(19) United States
(12) Patent Application Publication
(10) Pub. No.: US 2005/0186435 A1
(43) Pub. Date: Aug. 25, 2005

(54) Light emitting device and method for manufacturing the same

(75) Inventors: Shucheng Chu, Hamamatsu-shi (JP); Hirofumi Kan, Hamamatsu-shi (JP)

Correspondence Address: MORGAN LEWIS & BOCKIUS LLP, 1111 PENNSYLVANIA AVENUE NW, WASHINGTON, DC, 20004, US

(73) Assignee: HAMAMATSU PHOTONICS K.K.

(21) Appl. No.: 11/066,318

(22) Filed: Feb. 25, 2005

Related U.S. Application Data
(63) Continuation-in-part of application No. PCT/JP03/10961, filed on Aug. 28, 2003.

(30) Foreign Application Priority Data
Aug. 30, 2002 (JP) P2002-255007

(51) Int. Cl. B32B 9/04; B32B 15/18

(52) U.S. Cl. 428/446; 428/448; 148/518; 148/537

(57) ABSTRACT

A light emitting device (10) comprises a β-FeSi₂ film (2) provided on a front surface of a Si substrate (1), first electrode (3) provided on a rear-surface side of the Si substrate (1), second electrodes 4 provided on a front-surface side of the β-FeSi₂ film (2). The β-FeSi₂ film (2) has the conductivity different from that of Si substrate (1). Between the Si substrate (1) and β-FeSi₂ film (2), a pn junction is formed. The β-FeSi₂ film (2) functions as a luminescent layer. Its luminescence properties are not influenced very much by the type and purity of the substrate.

### RELATED APPLICATIONS

This application is a continuation-in-part of international application No. PCT/JP03/10961, filed Aug. 28, 2003.

### BACKGROUND OF THE INVENTION

1. Field of the Invention

The present invention relates to a light emitting device and a method for manufacturing the same.

2. Related Background Art

In recent years, β-FeSi₂ has received great attention. β-FeSi₂ is abundant as a resource, and a harmless and chemically stable semiconductor. β-FeSi₂ is a direct transition-type semiconductor whose forbidden bandgap is approximately 0.85 eV. It is possible to epitaxially grow β-FeSi₂ on a Si substrate. Thus, β-FeSi₂ is expected to be a material having less environmental burden for next-generation light emitting/light receiving elements.

However, the characteristics of β-FeSi₂ have not been known well yet. No report to the effect that light emission was observed from a continuous β-FeSi₂ film has ever been made. There exists a report to the effect that a photoluminescence (PL) emission from FeSi₂ microcrystals embedded in a Si (100) substrate by an ion injection method or a molecular beam epitaxial (MBE) method. However, this light emission disappears immediately after raising the temperature of the substrate. Therefore, it is difficult to apply this light emission to light emitting devices. Furthermore, the light emission strongly depends on the kind of the substrate (FZ or CZ) and the size of the microcrystals. Accordingly, it is difficult to control the light emission.

### SUMMARY OF THE INVENTION

An object of the present invention is to provide a light emitting device having a β-FeSi₂ film on a Si substrate.

In one aspect, the present invention relates to a light emitting device. This light emitting device comprises: a Si substrate; a β-FeSi₂ film which is in contact with the Si substrate; and first and second electrodes which are provided on both sides of the Si substrate. The β-FeSi₂ film has an electrical conductivity type different from that of the Si substrate. The first and second electrodes sandwich the Si substrate and β-FeSi₂ film therebetween.

In the light emitting device in accordance with the present invention, a pn junction is formed between the Si substrate and the β-FeSi₂ film. When an electric current is injected into this light emitting device via the first and second electrodes, the β-FeSi₂ film emits light. Since the β-FeSi₂ continuously placed on the Si acts as a luminescent layer, the luminescence properties of this light emitting device are not influenced very much by the kind and purity of the substrate.

In another aspect, the present invention relates to a method for manufacturing a light emitting device. This method manufactures a light emitting device comprising a Si substrate, a β-FeSi₂ film which is in contact with the Si substrate, and first and second electrodes which are provided on both sides of the Si substrate. The β-FeSi₂ film has an electrical conductivity type different from that of the Si substrate. The first and second electrodes sandwich the Si substrate and the β-FeSi₂ film therebetween. This method comprises: thermally cleaning the Si. substrate; forming an initial layer made of β-FeSi₂ on the Si substrate at a first temperature; growing the initial layer at a second temperature higher than the first temperature to form a β-FeSi₂ film; and annealing the β-FeSi₂ film at a third temperature higher than the second temperature.

This method can manufacture the above-described light emitting device. By forming an initial layer and then growing the same, the β-FeSi₂ film with high crystallinity is formed on the Si substrate.

The present invention will be more fully understood from the following detailed description and the accompanying drawings. The accompanying drawings are only illustrative and are not intended to limit the scope of the present invention.

Further scope of applicability of this invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a sectional view showing a light emitting device according to an embodiment.

FIG. 2 is a plan view of the light emitting device shown in FIG. 1.

FIG. 3 is a graph showing EL intensity when an electric current is injected into the light emitting device shown in FIG. 1.

FIG. 4 is a graph showing the results of an X-ray diffraction analysis for an unannealed β-FeSi₂ film on a Si substrate.

FIG. 5 is a graph showing the relationship between the photon energy and the absorption coefficient squared for a β-FeSi₂ film on a Si substrate.

### DESCRIPTION OF THE PREFERRED EMBODIMENTS

Embodiments of the present invention will now be described in detail with reference to the accompanying drawings. In the description of the drawings, identical symbols are used for identical elements, and these elements will not be explained repeatedly.

### First Embodiment

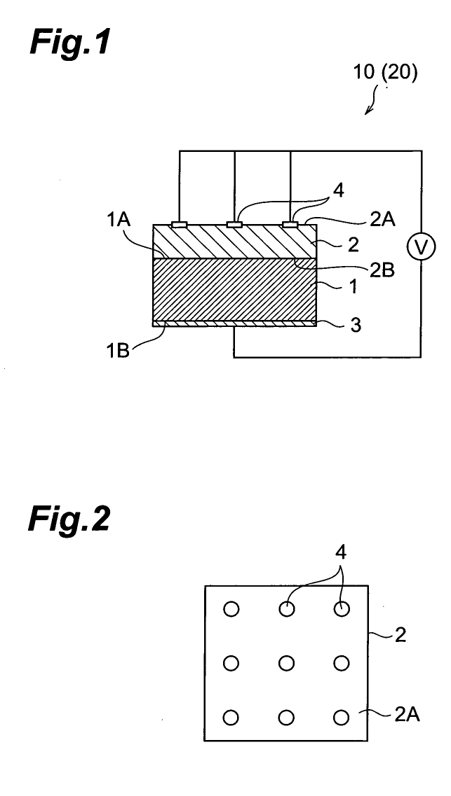

FIG. 1 is a sectional view showing a light emitting device 10 according to a first embodiment of the present invention. FIG. 2 is a plan view of the light emitting device 10. The light emitting device 10 is configured of a Si substrate 1, a β-FeSi₂ film 2, a lower electrode 3, and upper electrodes 4. The β-FeSi₂ film 2 and the upper electrodes 4 are provided on the front side of the substrate 1. The lower electrode 3 is provided on the back side of the substrate 1. The lower electrode 3 and the upper electrodes 4 sandwich the substrate 1 and β-FeSi₂ film 2 therebetween.

The Si substrate 1 is an n-type Si (111) substrate manufactured by Czochralski (CZ) method, that is, a substrate with a principal surface having a plane orientation of (111). The size of the substrate 1 is 2 inches. The substrate 1 has a front side 1A and a back side 1B which are positioned opposite each other.

The β-FeSi₂ film 2 is provided on the Si substrate 1 so as to cover the whole of the front side 1A of the Si substrate 1. The β-FeSi₂ film 2 has a front surface 2A and a back surface 2B which are positioned opposite each other. The back surface 2B is in contact with the front side 1A of the Si substrate 1. The thickness of the β-FeSi₂ film 2 is, preferably, 100-250 nm, and more preferably, 100-200 nm. In the present embodiment, the thickness of the β-FeSi₂ film 2 is 200 nm. Different from the Si substrate 1, the electrical conductivity type of the β-FeSi₂ film is p-type.

The first electrode 3 is, as shown in FIG. 1, provided on the Si substrate 1 so as to cover the whole of the back surface 1B of the Si substrate 1. The electrode 3 is made of Al metal.

The second electrodes 4 are, as shown in FIG. 1 and FIG. 2, provided on the front surface 2A of the β-FeSi₂ film 2 at regular intervals. The planar shape of the electrodes 4 is circular. Similar to the electrode 3, the electrodes 4 are made of Al metal.

A method for manufacturing the light emitting device 10 will now be described. First, the temperature of the Si substrate 1 is raised to thermally clean the Si substrate 1. In this cleaning process, the temperature of the substrate 1 is raised to 850° C. under a background pressure of 2×10⁻⁷ Torr, and the raised temperature is maintained for 30 minutes.

Next, on the front side 1A of the substrate 1 on which the thermal cleaning has been applied, a thin initial layer of β-FeSi₂ is formed. To form the initial layer, a high vacuum sputtering device, more specifically, an RF magnetron sputtering device including a load lock unit, may be used. A known RF magnetron sputtering device may be used. The RF magnetron sputtering device can form a β-FeSi₂ film at low temperature and high speed.

The growth temperature is preferably 440 to 550° C., and more preferably, 480-520° C. In this embodiment, the growth temperature is 500° C. Under this temperature, an Fe target with a purity of 99.99% is sputtered to form a β-FeSi₂ initial layer. The electrical conductivity type of this initial layer is p-type. The thickness of the initial layer is preferably 5-80 nm. In this embodiment, the thickness of the initial layer is 20 nm. During the formation of the initial layer, the argon pressure is controlled at 3×10⁻³ Torr.

Subsequently, the temperature of the substrate 1 having the initial layer formed thereon is raised to 730-760° C. in the RF magnetron sputtering device to grow the β-FeSi₂ initial layer at a speed of 35 nm/hour to be of a thickness of 200 nm. The film thickness of β-FeSi₂ is measured by observing a cross section of the grown film by use of a scanning electron microscope (SEM). The obtained β-FeSi₂ film is has a nearly flat front surface. The conductivity type thereof is p-type. The hole concentration of the β-FeSi₂ film is on the order of 10¹⁸ cm⁻³ at room temperature, and the hole mobility thereof is approximately 20 cm²/V·s at room temperature.

Next, the β-FeSi₂ film is annealed to obtain the β-FeSi₂ film 2 of the light emitting device 10 of the present embodiment. The temperature of the heat annealing is preferably 790-850° C. In the present embodiment, the annealing temperature is 800° C. In this heat annealing, the Si substrate 1 on which the β-FeSi₂ film has been formed is exposed to an 800° C. nitrogen atmosphere for 20 hours. This heat annealing is carried out in a silica tube. The conductivity type of the β-FeSi₂ film remains as p-type. As a result, a pn junction is formed between the n-type Si substrate 1 and the p-type β-FeSi₂ film 2. After the β-FeSi₂ film 2 is annealed at 800° C., the hole concentration thereof is reduced to the order of 1016 cm⁻³ at room temperature, and the hole mobility thereof is increased to 100 cm²/V·s at room temperature.

Then, the electrodes are formed on the front side and back side of the Si substrate 1. More specifically, the lower electrode 3 is formed by vacuum depositing Al metal on the back side 1B of the Si substrate 1. Also, the upper electrodes 4 are formed by vacuum depositing Al metal by use of masking on the front surface 2A of the β-FeSi₂ film 2. Either the lower electrode 3 or the upper electrodes 4 may be formed first. When these electrodes 3 and 4 have been formed, the light emitting device 10 of the present embodiment is completed.

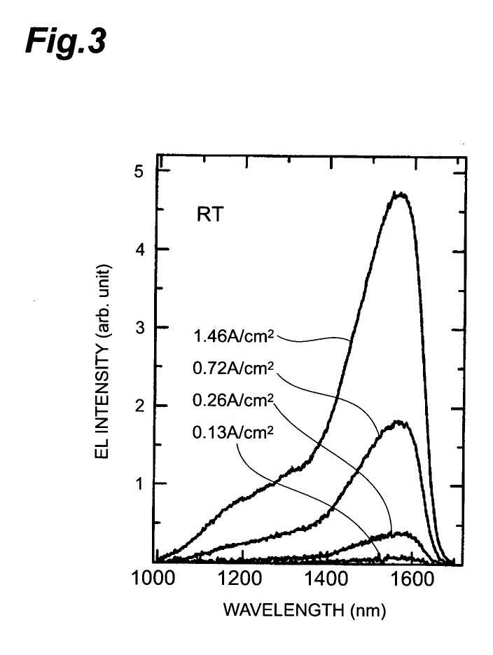

When a direct current was injected into the heterostructure of p-type β-FeSi₂ film 2/n-type CZ-Si substrate 1, which was obtained in the manner described above, via the Al electrodes 3 and 4, a light emission with a wavelength band around 1.5 μm was detected at room temperature. FIG. 3 shows the dependency of the electroluminescence (EL) spectrum on the forward current. As is apparent from FIG. 3, the EL intensity becomes stronger as a higher current is injected.

The light emitting device 10 has the β-FeSi₂ film 2 continuously provided on the Si substrate 1 as a luminescent layer. Therefore, the luminescence properties are not influenced very much by the kind and purity of the substrate. Accordingly, it is easy to control the manufacturing processes for the light emitting device 10.

A large-area wafer having a plurality of uniform light emitting devices 10 thereon can be manufactured by use of sputtering. Since sputtering can be simply performed at low cost, the light emitting devices 10 can be mass-produced at low cost.

### Second Embodiment

Hereinafter, a second embodiment of the present invention will be described. The inventors have discovered that when annealing of a β-FeSi₂ film is carried out at a higher temperature, the conductivity type of the β-FeSi₂ film is changed from p-type to n-type. In the present embodiment, by utilizing this change in the conductivity type, a light emitting device having an n-type β-FeSi₂ film on a p-type Si substrate is manufactured.

Similar to the first embodiment, a light emitting device 20 of the present embodiment has the construction shown in FIG. 1. However, the kind and the conductivity type of the substrate 1 and the conductivity type of the β-FeSi₂ film 2 are different from those in the first embodiment.

The Si substrate 1 is a p-type Si (111) substrate manufactured by a floating zone (FZ) method. The size of the substrate is 2 inches.

The conductivity type of the β-FeSi₂ film 2 is n-type, which is different from the conductivity type of the Si substrate 1. The β-FeSi₂ film 2 is provided on the Si substrate 1 so as to cover the whole of the front side 1A of the Si substrate 1.

A method for manufacturing the light emitting device 20 will now be described. Similar to the first embodiment as described above, this method includes a cleaning process, an initial layer forming process, a growth process, and an annealing process.

In the cleaning process, similar to the first embodiment, the temperature of the substrate 1 is raised to 850° C. under a background pressure of 2×10⁻⁷ Torr, and the temperature is maintained for 30 minutes.

In the initial layer forming process, an Fe target with a purity of 99.99% is sputtered to form a β-FeSi₂ initial layer with a thickness of 5-80 nm. The growth temperature is 450° C. The conductivity type of the initial layer is p-type. For sputtering, an RF magnetron sputtering device is used. During the formation of the initial layer, the argon pressure is regulated at 3×10⁻³ Torr.

In the growth process, the temperature of the substrate 1 on which the initial layer has been formed is raised to 700-760° C. in the RF magnetron sputtering device to grow the β-FeSi₂ initial layer to be of a thickness of 250 nm. The conductivity type of the grown β-FeSi₂ film remains as p-type. The hole concentration of the β-FeSi₂ film is on the order of 2×10¹⁸ cm⁻³ at room temperature, and the hole mobility thereof is approximately 20 cm²/V·s at room temperature.

Next, the β-FeSi₂ film is annealed. The temperature of the heat annealing is preferably 880-900° C. In the present embodiment, the annealing temperature is 890° C. In this heat annealing, the Si substrate 1 on which the β-FeSi₂ film has been formed is exposed to an 890° C. nitrogen atmosphere for 20 hours. This heat annealing is carried out in a silica tube. The conductivity type of the β-FeSi₂ film is changed to n-type from p-type. As a result, a pn junction is formed between the p-type Si substrate 1 and the n-type β-FeSi₂ film 2. Owing to the 890° C. annealing, the carrier concentration decreases and the mobility increases. More specifically, the electron concentration of 3-10×10¹⁶ cm⁻³ and the mobility up to 230 cm²/V·s are obtained.

After the annealing process, the lower electrode 3 and the upper electrodes 4 are formed similarly as in the first embodiment. Thereby, the light emitting device 20 of the present embodiment is completed.

It is possible to cause the light emitting device 20 to emit light at room temperature by injecting a direct current into the heterostructure of n-type β-FeSi₂ film 2/p-type FZ-Si substrate 1, which is obtained in the manner described above, via the Al electrodes 3 and 4. As such, in the present embodiment as well, the light emitting device 20 having the β-FeSi₂ film 2 continuously provided on the Si substrate as a luminescent layer can be obtained.

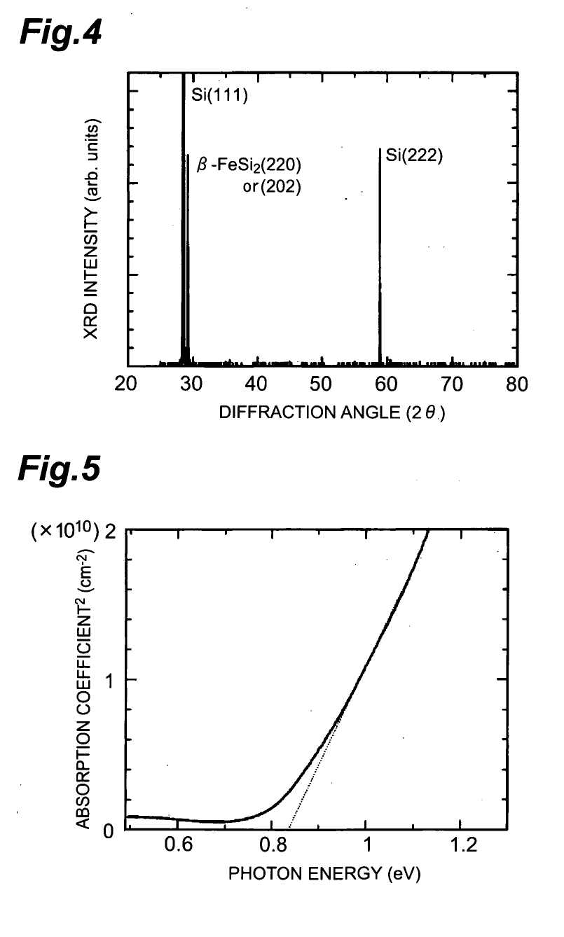

The inventors carried out an X-ray diffraction analysis for the β-FeSi₂ film, which was grown on the Si substrate 1, before annealing it. FIG. 4 is a graph showing the results. This X-ray diffraction analysis was carried out by use of a four-crystal diffractometer.

As shown in FIG. 4, only one peak appeared over a wide range of diffraction angles for the β-FeSi₂ film 2. Namely, a peak of β-FeSi₂ (220) or (202) was detected next to the substrate signal. Therefore, the β-FeSi₂ film is highly (110) or (101) oriented.

The rocking curve (ω scan) of the β-FeSi₂ peak has a full width at half maximum (FWHM) of 15 arcmin. This means that the β-FeSi₂ peak is quite narrow. Thus, the β-FeSi₂ film has high crystallinity.

The inventors examined in-plane epitaxial arrangements for the sample shown in FIG. 4. The result of the examination shows that [001] direction—rather than [010]—of β-FeSi₂ is parallel to [110] direction of the Si substrate, which strongly supports (110) orientation in the growth direction of the β-FeSi₂ film.

Furthermore, the inventors examined the relationship between the photon energy and the absorption coefficient of the β-FeSi₂ film at room temperature. FIG. 5 is a graph showing the results. In FIG. 5, the straight line shown as a broken line indicates that the direct transition is possible. This straight line provides a bandgap of 0.82 eV at an intersection between the straight line and the energy axis (horizontal axis).

It is also possible to directly grow the continuous and highly-oriented β-FeSi₂ film on the Si substrate immediately after the thermal cleaning without forming the initial layer. However, according to the results of the X-ray diffraction analysis, the ω scan full width at half maximum in the case where no initial layer is formed is wider by 30% than that of the case where the initial layer is formed. Therefore, forming the initial layer makes it possible to obtain a β-FeSi₂ film with higher crystallinity.

In the above-described embodiment, the β-FeSi₂ film is formed on a p-type FZ-Si substrate. However, it can be considered that even when a p-type CZ-Si substrate is used, a β-FeSi₂ film having high crystallinity can be obtained by forming and growing the initial layer.

A light emitting device in accordance with the present invention has a β-FeSi₂ film provided on a Si substrate as a luminescent layer. Since the luminescent layer is not microcrystals inside the substrate but a continuous film on the substrate, the luminescence properties of the light emitting device in accordance with the present invention are not influenced very much by the kind and purity of the substrate. Therefore, the light emitting device in accordance with the present invention can be manufactured by manufacturing processes which are easy to control.

In the above, the present invention has been described in detail based on the embodiments thereof. However, the present invention is not limited to the foregoing embodiments, and may be variously modified without departing from the scope thereof.

For example, in the foregoing embodiments, the electrodes 4 are provided so as to contact the front surface 2A of the β-FeSi₂ film. However, it may be also possible to form a Si cap layer on the β-FeSi₂ film and provide the electrodes on this cap layer. By providing the cap layer, improvement in light emission efficiency can be expected.

Also, in the foregoing embodiments, the RF magnetron sputtering device is used as a high-vacuum sputtering device to manufacture a β-FeSi₂ film on the substrate. However, a magnetron sputtering device by another system may be used. Nevertheless, the RF magnetron sputtering deposition method can be preferably used to provide a continuous and highly-oriented β-FeSi₂ film on a Si (111) substrate.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A light emitting device comprising:
a Si substrate;
a β-FeSi₂ film which is in contact with the Si substrate and has an electrical conductivity type different from that of the Si substrate; and
first and second electrodes which are provided on both sides of the Si substrate and sandwich the Si substrate and the β-FeSi₂ film therebetween.

2. The light emitting device according to claim 1, wherein the conductivity type of the Si substrate is n-type, and the conductivity type of the β-FeSi₂ film is p-type.

3. The light emitting device according to claim 1, wherein the conductivity type of the Si substrate is p-type, and the conductivity type of the β-FeSi₂ film is n-type.

4. The light emitting device according to claim 1, wherein the Si substrate has an orientation of (111), and the β-FeSi₂ film has an orientation of (110) or (101).

5. A method for manufacturing a light emitting device including a Si substrate, a β-FeSi₂ film which is in contact with the Si substrate and has an electrical conductivity type different from that of the Si substrate, and first and second electrodes which are provided on both sides of the Si substrate and sandwich the Si substrate and the β-FeSi₂ film therebetween, the method comprising:
thermally cleaning the Si substrate;
forming an initial layer made of β-FeSi₂ on the Si substrate at a first temperature;
growing the initial layer at a second temperature higher than the first temperature to form a β-FeSi₂ film; and
annealing the β-FeSi₂ film at a third temperature higher than the second temperature.

6. The method according to claim 5, wherein the first temperature is in a range of 440 to 550° C.

7. The method according to claim 5, wherein the second temperature is in a range of 700 to 760° C.

8. The method according to claim 5, wherein the third temperature is in a range of 790 to 850° C.

9. The method according to claim 5, wherein the third temperature is in a range of 880 to 900° C.

10. The method according to claim 5, wherein
the thermally cleaning the Si substrate includes thermally cleaning the Si-substrate of n-type,
the forming an initial layer includes forming the initial layer of p-type on the Si substrate, and
the growing the initial layer includes growing the initial layer so as to form the β-FeSi₂ film of p-type.

11. The method according to claim 5, wherein
the thermally cleaning the Si substrate includes thermally cleaning the Si-substrate of p-type,
the forming an initial layer includes forming the initial layer of p-type,
the growing the initial layer includes growing the initial layer so as to form the β-FeSi₂ film of p-type, and
the annealing the β-FeSi₂ film includes changing the electrical conductivity type of the β-FeSi₂ film from p-type to n-type.

12. The method according to claim 5, wherein the Si substrate has an orientation of (111).

13. The method according to claim 5, wherein the forming an initial layer on the Si substrate includes forming the β-FeSi₂ film by an RF magnetron sputtering method.

14. The method according to claim 5, wherein the growing the initial layer includes growing the β-FeSi₂ film by an RF magnetron sputtering method.
